(19) United States
(12) Patent Application Publication
(10) Pub. No.: US 2014/0022780 A1
(43) Pub. Date: Jan. 23, 2014

(54) LED-BASED LIGHTING UNIT WITH A HIGH FLUX DENSITY LED ARRAY

(71) Applicants: Brian Roberge, Franklin, MA (US); Nadezhda Piskun, Sudbury, MA (US); Gerard Carl Christopher, JR., Everett, MA (US)

(72) Inventors: Brian Roberge, Franklin, MA (US); Nadezhda Piskun, Sudbury, MA (US); Gerard Carl Christopher, JR., Everett, MA (US)

(73) Assignee: KONINKLIJKE PHILIPS N.V., Eindhoven (NL)

(21) Appl. No.: 14/009,895

(22) PCT Filed: Apr. 12, 2012
(86) PCT No.: PCT/IB2012/051785

§ 371 Date: Oct. 4, 2013

Related U.S. Application Data
(60) Provisional application No. 61/474,445, filed on Apr. 12, 2011.

(51) Int. Cl. F21K 99/00

(52) U.S. Cl. CPC F21K 9/54
USPC 362/231

(57) ABSTRACT

Methods and apparatus related to a LED-based lighting unit having a high flux density LED array (70). The LED based lighting unit may include an array of LEDs (70) of various spectra and the LEDs may be are arranged so as to occupy a substantial percentage of the area generally defined by the outermost extent of the array of LEDs. The various color LEDs may optionally be intermixed with certain parameters to provide for desired color mixing from the LEDs. The LED-based lighting unit may optionally be implemented in a lighting fixture such as an entertainment lighting fixture.

### TECHNICAL FIELD

The present invention is directed generally to a LED-based lighting unit. More particularly, various inventive methods and apparatus disclosed herein relate to a LED-based lighting unit having a high flux density LED array that includes a plurality of LEDs of various colors.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Entertainment lighting fixtures are known that utilize non-LED light sources, such as incandescent lamps. For example, a popular stage lighting fixture is the SOURCE FOUR, available from Electronic Theatre Controls (ETC) of Middleton, Wis. The SOURCE FOUR utilizes either a HID lamp as a light source or a proprietary halogen HPL lamp. Typical optical system losses from the SOURCE FOUR or similar fixtures may range from, for example, 40-60% from initial lamp lumens. Moreover, the rated lifetime of lamps utilized in such fixtures may only be approximately one thousand hours. Thus, lamps require frequent changeouts to maintain a desired lighting output from the lighting fixture.

Furthermore, in order to achieve any color effects from the SOURCE FOUR or similar conventional fixture, it is typically necessary to utilize gels. Due to their transmission coefficient, gels considerably cut the light output of an associated fixture. Moreover, gels tend to brown or burn up over time due to the extreme heat caused by the utilized incandescent lamp(s). Thus, the gels reduce light output of a fixture and require frequent change outs to maintain a desired lighting level and/or color from the fixture.

It has been proposed to utilize an LED light source in lieu of the incandescent light source in entertainment lighting fixtures. The LED light source in such fixtures attempts to replicate the light output of the incandescent source and may be utilized in combination with gels as desired. However, such entertainment lighting fixtures utilizing an LED light source suffer from one or more drawbacks. For example, the LED lighting fixtures may be unable to obtain a desired intensity and/or color from the LED light source. Also, for example, when utilized with gobos or other effects, the LED light source may be unable to produce a desired clean hard edge. Instead, the LED light source often causes unacceptable levels of color fringing or chromatic aberration.

Thus, there is a need in the art to provide a LED-based lighting unit that provides satisfactory intensity and/or color performance and/or provides a satisfactory hard edge when utilized with gobos or other effects and that may optionally be utilized in entertainment lighting fixtures.

### SUMMARY

The present disclosure is directed to inventive methods and apparatus for a LED-based lighting unit having a high flux density LED array that includes a plurality of LEDs of various colors. For example, an LED based lighting unit may include an array of optionally high brightness LEDs of various spectra and the LEDs may be arranged so as to occupy a substantial percentage of the area generally defined by the outermost extent of the array of LEDs. The various color LEDs may optionally be intermixed with certain parameters to provide for desired color mixing from the LEDs. The LED-based lighting unit may optionally include a single reflector provided around the entirety of the array of LEDs. Optionally, the single reflector may be free of diffusers or other light altering lens. The LED-based lighting unit may be implemented in a lighting fixture, such as an entertainment lighting fixture.

Generally, in one aspect, an LED-based lighting unit is provided that includes a circuit board having a high density array of LED connection pads. Each of the LED connection pads is electrically connected to a single of a plurality of individual channels of the circuit board. The circuit board further includes a plurality of filled vias. At least some of the vias extend between a portion of a single of the LED connection pads and one of a plurality of interior conductive traces each electrically coupled to a single of the individual channels. A plurality of surface mount LEDs are each coupled to a single of the LED connection pads. The LEDs are of at least five different spectra. Each of the LEDs of a single of the spectra is electrically connected to a single of the channels and has a peak wavelength that varies from at least two other of the spectra by at least twenty nanometers. At least seventy percent of an area within which the LEDs are placed is occupied by the LEDs. The area being generally defined by a shape conforming to the outermost extent of the LEDs.

In some embodiments, at least eighty percent of the area within which the LED are placed is occupied by the LEDs. In some embodiments, the circuit board includes a metal core.

Also, at least seven different of the spectra may be provided. In some embodiments, the spectra include a first non-white spectrum. A plurality of the LEDs are of the first non-white spectrum and each of the LEDs of the first non-white spectrum is bordered only by the LEDs of a unique of the spectra.

In other embodiments, a plurality of the LEDs are of a non-white spectrum. A majority of the LEDs of the non-white spectrum are bordered only by the LEDs of a unique of the spectra. In yet other embodiments, a plurality of the LEDs are of a non-white spectrum and each of the LEDs of the non-white spectrum are bordered only by LEDs of a unique of the spectra.

The LEDs can be arranged in at least one substantially linear row.

In some embodiments, the lighting unit includes a single reflector surrounding all of the LEDs. In some versions of those embodiments the reflector includes a hollow interior that is diffuser free.

Generally, in another aspect, an LED-based lighting unit is provided that includes a circuit board having a high density array of LED connection pads. Each of the LED connection pads is electrically connected to a single of a plurality of individual channels of the circuit board. A plurality of surface mount LEDs are included and each is coupled to a single of the LED connection pads. A single reflector surrounds all of the LEDs. The LEDs are of at least five different spectra. Each of the LEDs of a single of the spectra is electrically connected to a single of the channels and has a peak wavelength that varies from at least one other of the spectra by at least twenty nanometers. At least seventy percent of an area within which the LEDs are placed is occupied by the LEDs. The area is generally defined by a shape conforming to the outermost extent of the LEDs.

In some embodiments, at least eighty percent of the area within which the LEDs are placed is occupied by the LEDs. At least eight different of the spectra may be provided.

In some embodiments, the reflector is a horn type reflector and optionally includes a hollow interior that is diffuser free.

In some embodiments, the lighting unit further includes a heat dissipating structure in thermal connectivity with the circuit board. The heat dissipating structure optionally includes a heat slug adjacent the circuit board and a plurality of heat pipes extending from the heat slug into a plurality of cooling fins. In some versions of those embodiments, the lighting unit further includes a support structure supporting the circuit board and in direct contact with at least one of the cooling fins and the heat slug.

Generally, in another aspect, an entertainment lighting fixture is provided that includes a circuit board having a high density array of LED connection pads. Each of the LED connection pads is electrically connected to a single of a plurality of individual channels of the circuit board. A plurality of surface mount LEDs are included and each is coupled to a single of the LED connection pads. The lighting unit also includes a single reflector that has a base surrounding all of the LEDs and a top distal the base. The top defines a reflector light output opening. A housing surrounds the circuit board, the LEDs, and the single reflector. The housing defines a housing light output opening that is in optical communication with the reflector light output opening. The LEDs are of at least three different spectra. Each of the LEDs of a single of the spectra is electrically connected to a single of the channels and has a peak wavelength that varies from at least one other of the spectra by at least twenty nanometers. The reflector is diffuser free between the base and the reflector light output opening.

In some embodiments, the entertainment lighting fixture is diffuser free between the reflector light output opening and the housing light output opening.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectra of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an exploded perspective view of an embodiment of a stage lighting fixture having an LED-based lighting unit with a high flux density LED array; the outer housing of the stage lighting fixture is not illustrated in FIG. 1.

FIG. 2 illustrates a perspective view of the stage lighting fixture of FIG. 1; a portion of the outer housing of the stage lighting fixture is removed to better show certain components of the stage lighting fixture.

FIG. 3 illustrates a plan view of the LEDs and circuit board of the embodiment of the LED-based lighting unit of FIG. 1.

FIG. 4A illustrates a plan view of an internal conduction layer of the circuit board of FIG. 3.

FIG. 4B illustrates a plan view of a top conduction layer of the circuit board of FIG. 3.

### DETAILED DESCRIPTION

Entertainment lighting fixtures are known that utilize non-LED light sources, such as incandescent lamps. However, such lighting fixtures suffer from optical system output degradation and/or a short lamp lifetime. Thus, the lamps of such lighting fixtures require frequent changeouts to maintain a desired lighting level from the fixture. Moreover, in order to achieve any color effects from such lighting fixtures, it is necessary to utilize gels. Gels considerably cut light output and brown or burn up over time. Thus, the gels reduce light output of a fixture and require frequent change outs to maintain a desired lighting level and/or color from the fixture.

It has been proposed to utilize an LED light source in lieu of the incandescent light source in entertainment lighting fixtures. However, such entertainment lighting fixtures utilizing an LED light source suffer from one or more drawbacks. For example, the LED lighting fixtures may be unable to obtain a desired intensity and/or color from the LED light source and/or may be unable to produce a desired clean hard edge when used with gobos or other effects.

Thus, Applicants have recognized and appreciated a need in the art to provide a LED-based lighting unit that provides satisfactory intensity and/or color performance and/or provides a satisfactory hard edge when utilized with gobos or other effects and that may optionally be utilized in entertainment lighting fixtures.

More generally, Applicants have recognized and appreciated that it would be beneficial to provide an LED-based lighting unit having a high flux density LED array that includes a plurality of LEDs of various colors.

In view of the foregoing, various embodiments and implementations of the present invention are directed to methods and apparatus related to an LED-based lighting unit and a lighting fixture having a LED-based lighting unit.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the claimed invention. For example, various embodiments of the apparatuses and methods disclosed herein are particularly suited for use in entertainment lighting fixtures. Accordingly, for illustrative purposes, the claimed invention may discussed herein in conjunction with such a lighting fixture. However, other configurations, applications, and implementations are contemplated without deviating from the scope or spirit of the claimed invention.

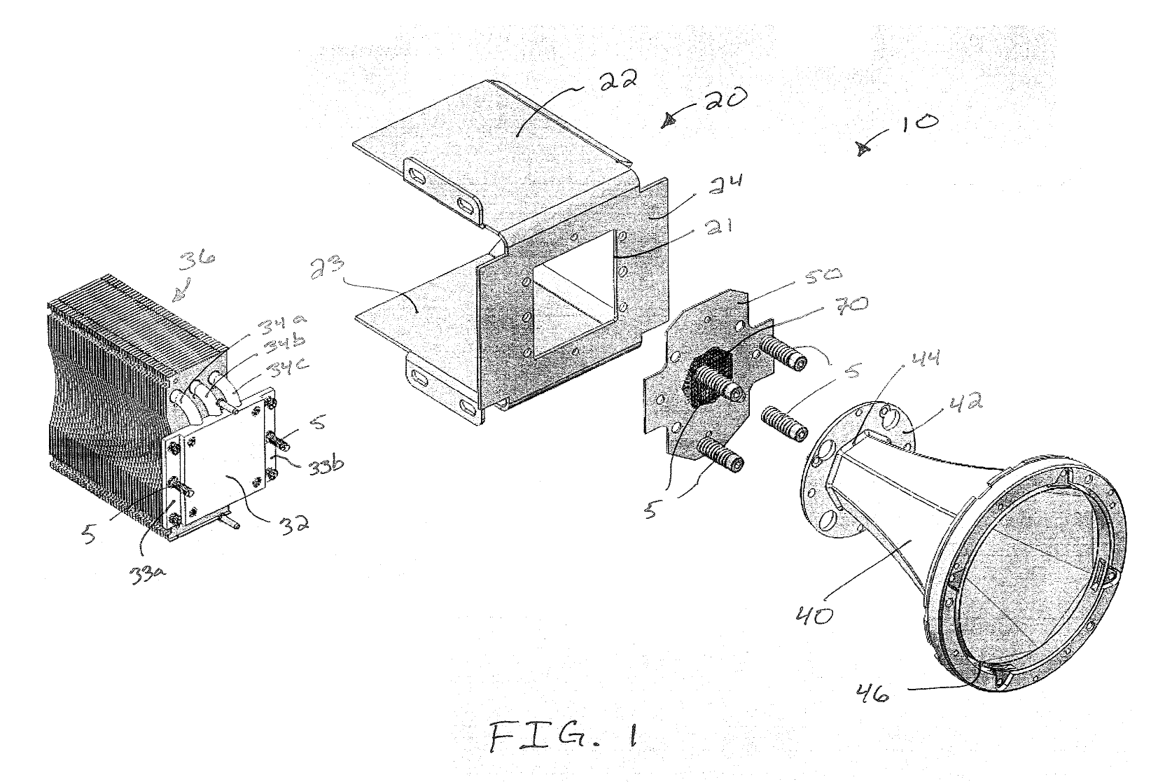

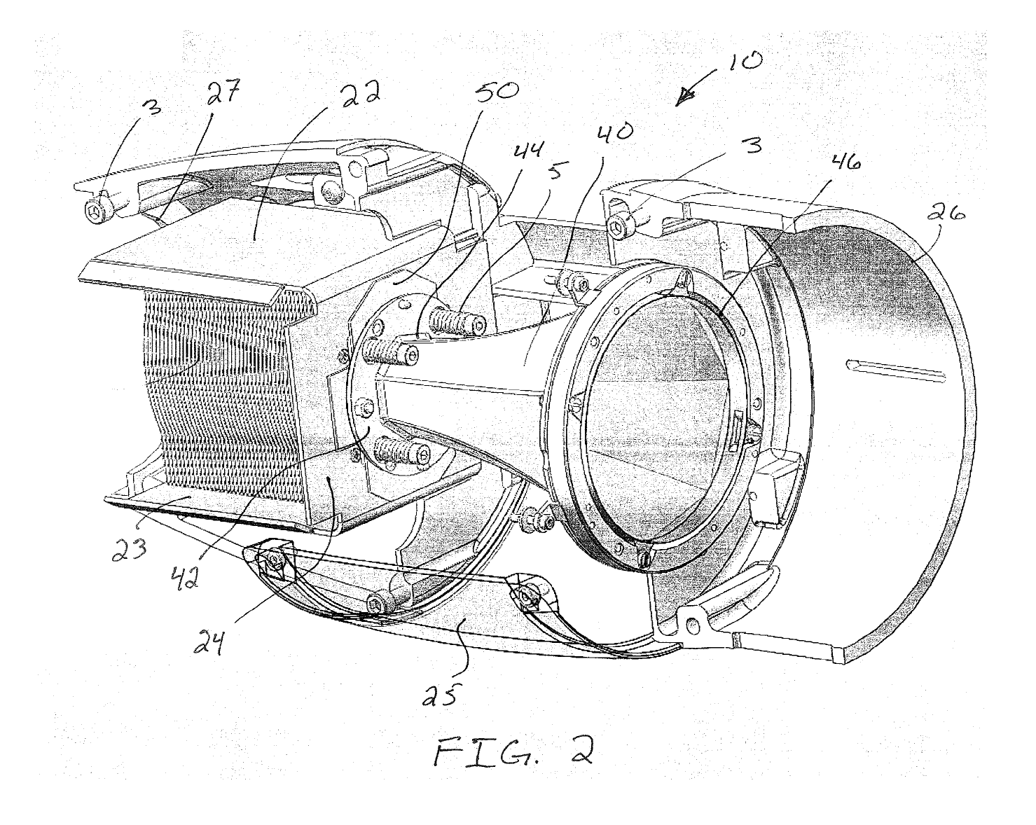

Referring to FIG. 1 and FIG. 2, in one embodiment an LED-based lighting unit may be implemented in a stage lighting fixture 10. FIG. 1 illustrates an exploded perspective view of the stage lighting fixture 10 without the outer housing 25 of the stage lighting fixture 10. FIG. 2 illustrates a perspective view of the stage lighting fixture 10 with only a portion of the outer housing 25 being shown to thereby better illustrate certain components of the stage lighting fixture 10. The missing portion of the outer housing 25 may be a substantial mirror image of the depicted portion of the outer housing 25 and may optionally be coupled thereto utilizing screws 3 or other fasteners.

The stage lighting fixture 10 includes a support structure 20 having a first wall 22 and opposed second wall 23 in generally parallel relationship with one another. A third wall 24 extends between and connects the first wall 22 and the second wall 23. The third wall 24 is generally perpendicular to the first and second walls 22, 23 and includes an opening 21 provided therethrough. The opening 21 receives a portion of heat slug 32 that is embossed relative to connection areas 33a and 33b of heat slug 32. The heat slug 32 is received in, and optionally extends completely through, the opening 21. In alternative embodiments the opening 21 may enable access to heat slug 32, but not receive a portion of heat slug 32 therein. The connection areas 33a and 33b each contain a plurality of fastener openings that align with respective fastener openings through third wall 24. The fastener openings may receive fasteners such as spring loaded fasteners 5 therethrough to enable, inter alia, the coupling of heat slug 32 to support structure 20.

The heat slug 32 includes three heat pipe recesses on a back surface thereof, each of which receives a portion of a respective of heat pipes 34a-c. The heat slug 32 may be manufactured from a heat absorbing metal and/or metal alloy such as Aluminum, Copper, and/or alloys thereof. The heat pipes 34a-c may optionally be power cooled heat pipes in some embodiments. The heat pipes 34a-c extend rearward from heat slug 32 through a plurality of cooling fins 36 and are in thermal connectivity with the cooling fins 36. The heat pipes 34a-c collect and dissipate heat from heat slug 32 and further disperse the collected heat to cooling fins 36.

Referring particularly to FIG. 2, it is illustrated that a portion of the perimeters of the cooling fins 36 are in close proximity to and/or in contact with the first wall 22 and/or second wall 23 of the support structure 20. The cooling fins 36 are in thermal contact with the first wall 22 and second wall 23 and further disperse heat that is collected via heat slug 32 to support structure 20. Also, connection areas 33a and 33b are in close proximity to and/or in contact with the third wall 24 of the support structure 20. The connection areas 33a and 33b are in thermal contact with the third wall 24 and further disperse heat that is collected via heat slug 32 to support structure 20. An opening 27 is provided at the rear of the housing 25 and provides for communication of air into and out of at least the rear portion of the housing 25 where support structure 20 and cooling fins 36 are housed to further assist in cooling. Optionally, one or more fans may be provided across all or portions of opening 27 to facilitate air flow into and/or out of housing 25.

A circuit board 50 is placed atop the heat slug 32 and in thermal contact therewith. Optionally, thermal paste, thermal pads, or other thermal interface may be provided between circuit board 50 and heat slug 32. The circuit board 50 may be coupled to support structure 20 utilizing, inter alia, one or more fasteners extending through fastener openings through circuit board 50 and third wall 24. The circuit board 50 includes a high flux density LED array 70 thereon that includes a plurality of high brightness LEDs of various colors.

A single horn reflector 40 is placed about and over the LED array 70. The reflector 40 includes a reflector base 44 that surrounds the LED array and flares upward and outward toward a reflector top 46. The reflector 40 includes a plurality of interior flared faces. A reflector support flange 42 extends radially from the reflector base 44 and contacts against the circuit board 50. The reflector support flange 42 includes a plurality of fastener openings therthrough that may receive fasteners, such as spring loaded fasteners 5, therethrough for attachment of the reflector 40 to the circuit board 50 and/or to the support 20. The reflector top 46 is surrounded by a flange of the housing 25 that extends inwardly from a hood of the housing 25. The hood of the housing 25 generally defines a light output opening 26 of the housing 25.

The depicted reflector is an asymmetric horn reflector 40 and is utilized in combination with a symmetric LED array 70. In some alternative embodiments a symmetric horn reflector may be utilized in combination with an asymmetric LED array 70. In other embodiments no reflector or non horn type reflectors may optionally be utilized. In the depicted lighting fixture there is no diffuser or other light altering lens present between the LED array 70 and the light output opening 26 of the housing 25. In alternative embodiments a diffuser may optionally be added along the optical path. For example, a diffuser may optionally be added across the reflector top 46. In some embodiments the reflector 40 and the housing 25 may be free of light altering lenses that substantially interfere with light output of the LED array 70. In some of those embodiments reflector 40 and/or housing 25 may optionally be provided with a protective non-light-altering lens.

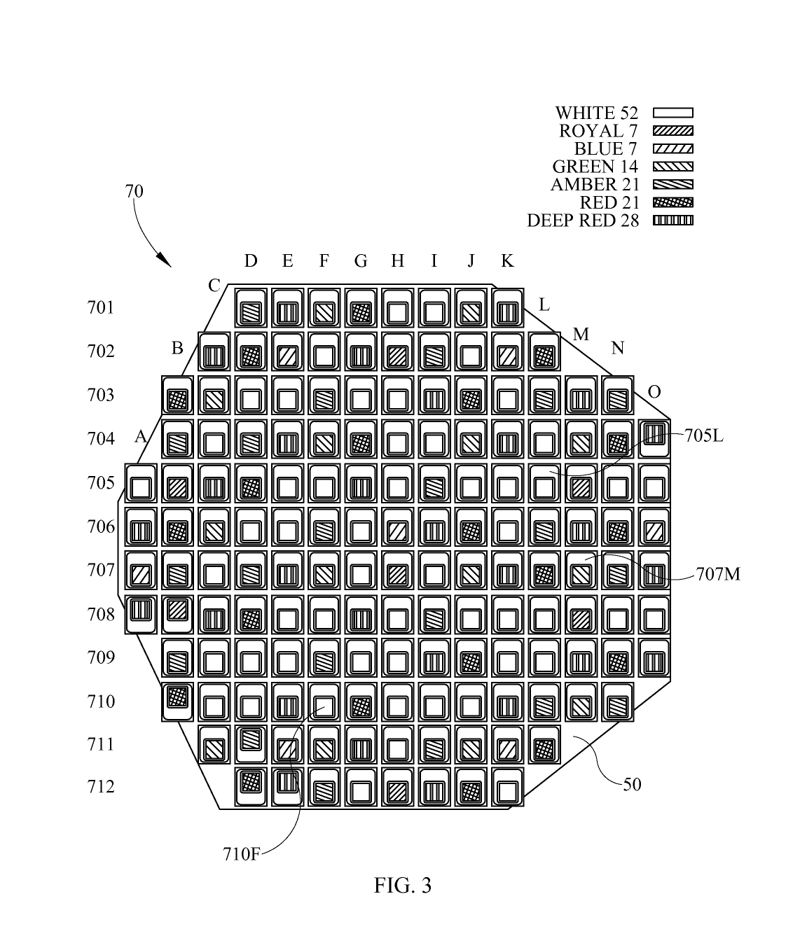

Referring to FIG. 3, a plan view of the LED array 70 and a portion of the circuit board 50 of the LED-based lighting unit of FIG. 1 is illustrated. The depicted LED array 70 includes fifteen columns of LEDs. The columns are referenced as columns A-O in FIG. 3 for ease of description of the LED array 70. The depicted LED array 70 includes twelve rows of LEDs. The rows of LED are labeled as rows 701-712 for ease of description of the LED array 70. Only three LEDs are particularly referenced with a lead line and a reference number in FIG. 3 for simplification: LEDs 705-L, 707-M, and 710-F. However, it is understood that other individual LEDs may be identified in this detailed description by a reference number that corresponds to the row and column in which the LED is located (In row-column format). For example, LED 705-L is in row 705, column L. In the depicted embodiment, the gap between each row of LEDs is approximately 0.2 mm and the gap between each column of LEDs is approximately 0.22 mm. Although linearly and symmetrically arranged LEDs are depicted in FIG. 3, one of ordinary skill in the art, having had the benefit of the present disclosure, will recognize that in alternative embodiments non-linear and/or non-symmetrical arrangements may be utilized.

A portion of each of the LEDs depicted in FIG. 3 is provided with a particular marking (or no marking) to generally identify what spectrum of light the LED emits. A chart is provided in FIG. 3 to assist in identifying which marking corresponds with which general spectrum. The portion of the LEDs that are marked (or corresponding unmarked small squares in the case of the white LEDs) generally represent the light emitting substrate of the LEDs, although not necessarily to scale. The rectangular unmarked portions surrounding the small squares generally represent the footprint of the entire LED packages.

The mixing of the various spectra of LEDs demonstrated in FIG. 3 and/or the density of the LEDs may limit the effect of chromatic aberration and provide a satisfactory hard edge when the lighting fixture 10 is utilized with gobos or other effects. In the depicted embodiment no single of the LEDs (with the exception of the white LEDs) is provided within one row or column of an LED emitting light of the same spectrum. In other words, in the depicted embodiment at least one LED of a unique color separates each non-white LED from a similarly colored LED. For example, LED 707-M emits green light and two LEDs are provided between LED 707-M and the closest green LEDs thereto (LEDs 707-J and 710-M).

In the depicted embodiment, one-hundred-and-fifty total LEDs are provided. Fifty-two white LEDs are provided, twenty-eight deep red, twenty-one red, twenty-one amber, fourteen green, seven blue, and seven royal. Although a particular number of LEDs are depicted and described herein, one of ordinary skill in the art, having had the benefit of the present disclosure, will recognize and appreciate that in alternative embodiments more or fewer LEDs may be provided. For example, in some embodiments, one-hundred-and-fifty-nine LEDs may be provided in substantially the same area. Also, for example, in some embodiments the number of LEDs can be scaled up or down to accommodate various optical windows and etude's to achieve desired and/or optimal system performance—optionally taking into account one or more factors such as, for example, lighting efficiency, beam quality, and/or beam angle.

Also, although a particular distribution of LEDs based on spectrum is depicted, one of ordinary skill in the art, having had the benefit of the present disclosure, will recognize and appreciate that in alternative embodiments different particular distributions may be provided to achieve desired light output characteristics. For example, the color and wavelength spectra of the LEDs are not limited to what has been illustrated in FIG. 3. For example, more or fewer colors of LEDs than those depicted may be utilized (optionally in combination with one or more colors illustrated in FIG. 3). In some embodiments, an EEPROM may be provided in combination with a controller and may store binning and calibration data. The controller may be able to control the LEDs based on the incoming data sequence to the fixture and the binning and calibration data. Also, in some embodiments, a thermal and/or optical sensor may additionally or alternatively be provided in combination with the LEDs in order to measure temperature(s) (e.g., temperature at one or more locations on the PCB) and/or optical output(s) from one or more LEDs. Data from the thermal and/or optical sensor may be fed to a controller for calibrating and controlling the overall color point of the lighting unit. For example, the controller may individually control one or more LEDs to achieve a desired color point. Utilizing a controller in combination with binning and calibration data and/or one or more sensors may, inter alia, allow fixture-to-fixture matching among an installation of a plurality of fixtures. In certain embodiments each of the LEDs may be driven at approximately the following currents and produce approximately the following lumens at sixty degrees Celsius: White: 0.5 Amps and 90.14 Lumens; Blue: 0.5 Amps and 11.89 Lumens; Green: 0.5 Amps and 66.9 Lumens; Amber: 0.35 Amps and 12.97 Lumens; Red: 0.5 Amps and 34.63 Lumens.

In the depicted embodiment, the LEDs are ultra compact high brightness surface mount LEDs such as, for example, LEDs typically used for a camera flash or other consumer device. In some embodiments the LEDs may include, but not be limited to, CERAMOS LEDs and/or OSLON LEDs, both of which are available from OSRAM Opto Semiconductors, Inc. of Sunnyvale, Calif. The CERAMOS LEDs may optionally provide a package area utilization (chip area/substrate area) of approximately 27%. In the depicted embodiment the LEDs are arranged within a circle having a diameter of approximately 29 mm. In some embodiments, the interior of the reflector base 44 of reflector 40 may have a diameter of approximately 29 mm (approximately 660.52 mm²) and the LED array 70 may be arranged within an area such that it fits entirely interiorly of the reflector base 44. In versions of these embodiments each of the LEDs have a footprint of approximately 3.55 mm². Thus, in those versions, approximately 80.5% of the space within which the LEDs are arranged is actually being utilized for LED placement. In other words, approximately 80.5% of the area defined by the inner periphery of the reflector base 44 and/or a shape generally conforming to the bounds of the outermost LEDs, is being occupied by the actual chip of the LEDs and approximately 19.5% of the area is exposed circuit board. The epitaxial or optical window area utilization (chip area/window area) of the LEDs in these versions that also utilize the CERAMOS LEDS is approximately 22% (27% package area utilization multiplied by 80.5%).

In some embodiments, the LED array 50 may be configured to include one-hundred-and-fifty-nine LEDs arranged within an area of approximately 701 mm². In such embodiments the LEDs may have a footprint of approximately 3.55 mm² and utilize approximately 80.5% of the space defined by a shape conforming to the outermost extent of the LEDs. The LED array 50 enables an optical window area utilization that provides satisfactory light mixing of the LEDs for light output in entertainment lighting fixtures such as spot lighting fixtures. The depicted surface mount configuration of the LEDs may enable the LEDs to be reworked after reflow by enabling access to pads directly beneath the LEDs by a user and/or machine. In some embodiments packaged LEDs may be utilized so that larger variations of LEDs (e.g., LEDs having varying color/flux) can be accepted and populated on circuit board 50 as orders are received. In some versions of those embodiments binning software and/or active temperature adjustment of the LEDs may be utilized to achieve desired light output characteristics. In some embodiments the LEDS may be reworked with specialized tools and/or processes based on fine pitch ball grid array rework stations.

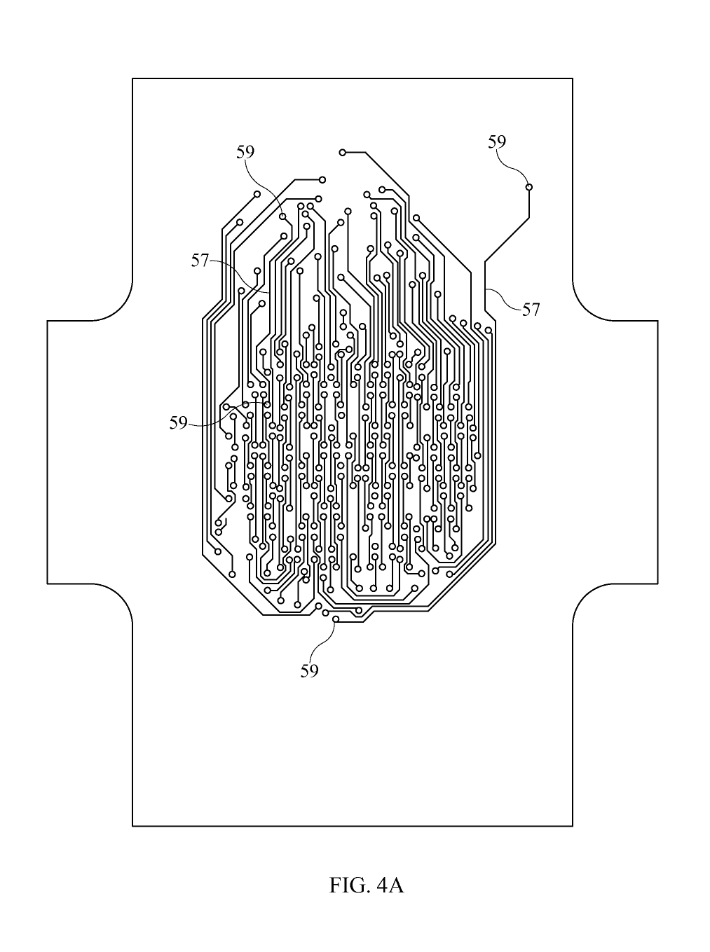

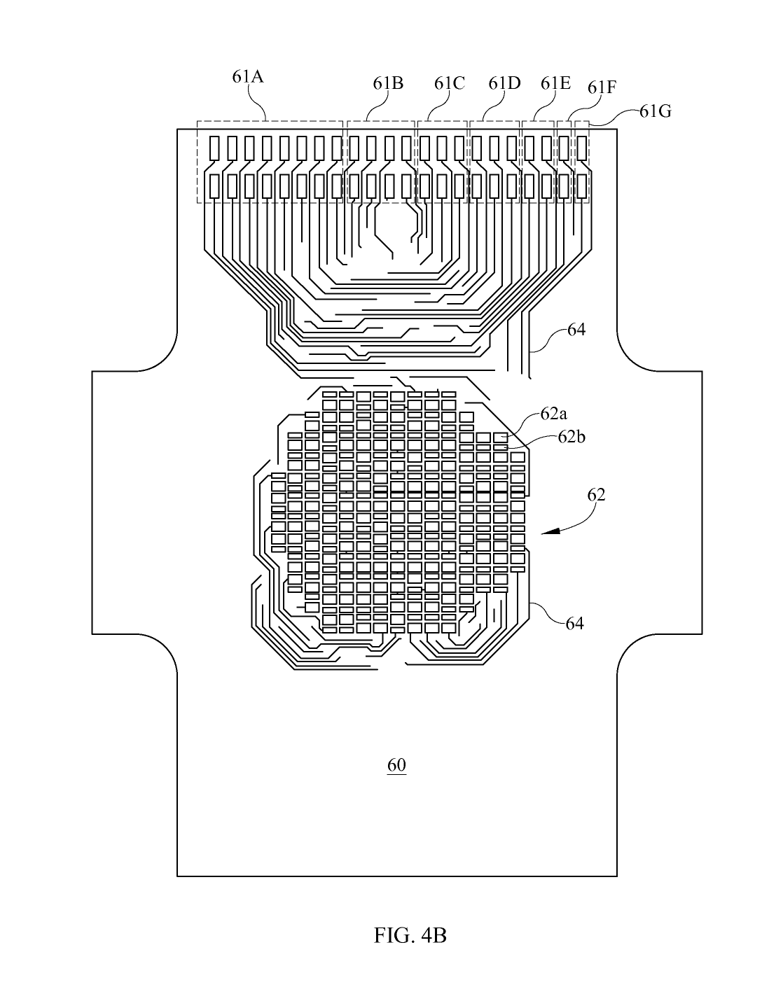

Referring now to FIG. 4A and FIG. 4B, the circuit board 50 is depicted in additional detail. The depicted circuit board 50 is a metal-core printed circuit board having two conductive layers. In alternative embodiments more layers may optionally be provided. Such layers may enable the connection of additional LEDs and/or may provide for more efficient thermal performance. The internal conductive layer 55 of the circuit board 50 is illustrated in FIG. 4A and the top conductive layer 60 of the circuit board 50 is illustrated in FIG. 4B. It is understood that a dielectric layer may be provided between the metal core and the internal conductive layer 55 and between the internal conductive layer 55 and the top conductive layer 60. Moreover, solder resist and/or solder may be added atop portions of the top conductive layer 60.

FIG. 4A illustrates a plan view of the internal conductive layer 55 and FIG. 4B illustrates a plan view of the top conductive layer 60. FIG. 4A and FIG. 4B are similarly sized and interconnections between layers 55 and 60 may be recognized by overlaying the two Figures and/or through a side-by-side comparison. The internal conductive layer 55 includes a plurality of traces 57, generally indicated as lines, each extending between, and in electrical connectivity with, vias 59, generally indicated as circles. For the sake of clarity, only some of the traces 57 and vias 59 are illustrated. Each of the vias 59 is in electrical and thermal connectivity with a portion of the upper layer 60. The vias 59 may be approximately three mils to eight mils in some embodiments. The vias 59 may optionally be filled to prevent voids under the solder pads over the top conductive layer 60, thereby preventing voids under the connection pads of the LEDs. Mechanical and/or laser drilling and/or other cutting may be utilized to create the vias 59. In some embodiments vias 59 may be created by laser cutting a hole through the dielectric layer that is between the upper conductive layer 60 and the internal conductive layer 55 and, optionally, through upper conductive layer 60. The vias 59 may optionally be filled with plating and/or epoxy. A hybrid di-electric design may optionally be utilized in one or more di-electric layers of the circuit board 50. A hybrid di-electric design is one where thinner di-electrics, di-electrics with better thermal resistances, and/or a wider choice of compatitable di-electrics may be utilized as compared to traditional standard 2 layer MCPCB designs.

The upper layer 60 includes eight separate electrical input channels 61A-G, each of which includes at least one positive and neutral connection pad pair. Input channel 61A includes eight separate connection pad pairs, input channel 61B includes four separate connection pad pairs, input channel 61C includes three separate connection pad pairs, input channels 61E includes two separate connection pad pairs, and input channels 61F and 61G include one connection pad pair each. Each of the connection pad pairs is in electrical communication with a plurality of LED mounts 62 each having a positive connection pad 62a and a neutral connection pad 62b. For the sake of clarity, only some of positive connection pad 62a and neutral connection pad 62b are labeled. In some embodiments the LED mounts 62 may also optionally include a separate thermal pad, optionally in between the positive connection pad 62a and neutral connection pad 62b. Such a thermal pad may interface with a thermal slug of an LED when it is attached and may be in thermal connectivity with non-powered portions of one or more conductive layers to help dissipate heat drawn thereto. Each of input channels 61A-G may be in electrical connection with a plurality of LED mounts 62 through electrical connection with traces 64 and/or through electrical connection with a pair of vias 59 and the trace 57 extending therebetween.

Each of the channels 61A-G corresponds to a single LED spectrum and each is in electrical communication with LEDs of a single LED spectrum when the board 50 is populated with LEDs. In particular, channel 61A corresponds to white LEDs, channel 61B corresponds to deep red LEDs, channel 61C corresponds to red LEDs, channel 61D corresponds to amber LEDs, channel 61E corresponds to green LEDs, channel 61F corresponds to blue LEDs, and channel 61G corresponds to royal blue LEDs. Other channel configurations may of course be utilized. Each of the channels 61A-G may be electrically coupled to an LED driver or other power source. One or more of the connection pad pairs in each of the channels 61A-G may be selectively powered to a desired level to provide for desired color output from the lighting fixture 10. For example, one or more connection pad pairs may be unpowered or powered at a reduced voltage (e.g., through altered pulse width modulation) to provide for desired color output. The plurality of channels of the circuit board 50 and plurality of colors of LEDs provided in the LED array 70 enable the color output of the lighting fixture 10 to be pulled to a desired color output within a large gamut of color outputs.

One or more controller may optionally be implemented on the circuit board 50 and/or electronically upstream of the circuit board 50 (e.g., in combination with external drivers) to control the power state and/or intensity of each of the individual channels 61A-G (or individual connection pad pairs of a channel). The controller(s) may interface with the channels 61A-G to achieve desired light output from the stage lighting fixture to achieve any desired of a wide range of color outputs therefrom, without necessitating the use of gels.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Any reference numerals or other characters, appearing between parentheses in the claims, are provided merely for convenience and are not intended to limit the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. An LED-based lighting unit, comprising:
a circuit board having a high density array of LED connection pads, each of said LED connection pads being electrically connected to a single of a plurality of individual channels of said circuit board; said circuit board further including a plurality of filled vias, at least some of said vias extending between a portion of a single of said LED connection pads and one of a plurality of interior conductive traces each electrically coupled to a single of said individual channels;
a plurality of surface mount LEDs each coupled to a single of said LED connection pads;
wherein said LEDs are of at least five different spectra, each of said LEDs of a single of said spectra electrically connected to a single of said channels and having a peak wavelength that varies from at least two other of said spectra by at least twenty nanometers;
wherein at least seventy percent of an area within which said LEDs are placed is occupied by said LEDs, said area being defined by a shape conforming to the outermost extent of said LEDs; and
a single reflector surrounding all of said LEDs and surrounding said area within which said LEDs are placed.

2. The LED-based lighting unit of claim 1, wherein at least eighty percent of said area within which said LED are placed is occupied by said LEDs.

3. The LED-based lighting unit of claim 1, wherein said circuit board includes a metal core.

4. The LED-based lighting unit of claim 1, wherein at least seven different of said spectra are provided.

5. The LED-based lighting unit of claim 1, wherein said spectra include a first non-white spectrum, wherein a plurality of said LEDs are of said first non-white spectrum, and wherein each of said LEDs of said first non-white spectrum is bordered only by said LEDs of a unique of said spectra.

6. The LED-based lighting unit of claim 1, wherein a plurality of said LEDs are of a non-white spectrum, and wherein a majority of said LEDs of said non-white spectrum are bordered only by said LEDs of a unique of said spectra.

7. The LED-based lighting unit of claim 1, wherein a plurality of said LEDs are of a non-white spectrum, and wherein each of said LEDs of said non-white spectrum are bordered only by said LEDs of a unique of said spectra.

8. The LED-based lighting unit of claim 1, wherein said LEDs are arranged in at least one substantially linear row.

9. (canceled)

10. The LED-based lighting unit of claim 1, wherein said reflector includes a hollow interior that is diffuser free.

11. An LED-based lighting unit, comprising:
a circuit board having a high density array of LED connection pads, each of said LED connection pads being electrically connected to a single of a plurality of individual channels of said circuit board;
a plurality of surface mount LEDs each coupled to a single of said LED connection pads; and
a single reflector surrounding all of said LEDs;
wherein said LEDs are of at least five different spectra, each of said LEDs of a single of said spectra electrically connected to a single of said channels and having a peak wavelength that varies from at least one other of said spectra by at least twenty nanometers;
wherein at least seventy percent of an area within which said LEDs are placed is occupied by said LEDs, said area being defined by a shape conforming to the outermost extent of said LEDs.

12. The LED-based lighting unit of claim 11, wherein at least eighty percent of said area within which said LED are placed is occupied by said LEDs.

13. The LED-based lighting unit of claim 11, wherein at least eight different of said spectra are provided.

14. The LED-based lighting unit of claim 13, wherein a plurality of said LEDs are of a non-white spectrum, and wherein a majority of said LEDs of said non-white spectrum are bordered only by said LEDs of a unique of said spectra.

15. The LED-based lighting unit of claim 11, wherein said reflector is a horn type reflector.

16. The LED-based lighting unit of claim 11, wherein said reflector includes a hollow interior that is diffuser-free.

17. The LED-based lighting unit of claim 11, further comprising a heat dissipating structure in thermal connectivity with said circuit board; said heat dissipating structure including a heat adjacent said circuit board and a plurality of heat pipes extending from said heat slug into a plurality of cooling fins.

18. The LED-based lighting unit of claim 17, further comprising a support structure supporting said circuit board and in direct contact with at least one of said cooling fins and said heat slug.

19-20. (canceled)

21. The LED-based lighting unit of claim 1, wherein said reflector (40) is a horn type reflector.

22. The LED-based lighting unit of claim 21, wherein said horn type reflector is one of asymmetric and symmetric and said LEDs are the other of asymmetric and symmetric.

23. The LED-based lighting unit of claim 1, further comprising a heat dissipating structure in thermal connectivity with said circuit board; said heat dissipating structure including a heat slug adjacent said circuit board and a plurality of heat pipes extending from said heat slug into a plurality of cooling fins.

24. The LED-based lighting unit of claim 23, further comprising a support structure supporting said circuit board and in direct contact with at least one of said cooling fins and said heat slug.

25. The LED-based lighting unit of claim 1, further comprising a housing surrounding said circuit board, said LEDs, and said single reflector, said housing defining a housing light output opening that is in optical communication with a light output opening of said reflector.

26. The LED-based lighting unit of claim wherein said reflector is free of light altering lenses that substantially interfere with light output of said LEDs.
